(19) United States
(12) Patent Application Publication
(10) Pub. No.: US 2019/0213306 A1
(43) Pub. Date: Jul. 11, 2019

(54) System and method for identity authentication

(71) Applicant: AuthenWare Corp., Miami, FL (US)

(72) Inventors: Daniel Caselles, Miami, FL (US); Felix Racca, Miami, FL (US)

(73) Assignee: AuthenWare Corp., Miami, FL (US)

(21) Appl. No.: 14/543,863

(22) Filed: Nov. 17, 2014

Related U.S. Application Data
(60) Provisional application No. 61/904,996, filed on Nov. 15, 2013.

(51) Int. Cl. G06F 21/31; G06F 21/32; G06F 3/0488

(52) U.S. Cl. CPC G06F 21/316; G06F 3/0488; G06F 21/32

(57) ABSTRACT

A method, authentication server and computer program product authenticate an identity of a user of an electronic device using biometric behavior. The electronic device has an input interface for receiving tapping data. A signature for authorizing user access to the electronic device or an application to be executed on the electronic device is received. The signature comprises tapping data having been input to the electronic device by tapping a series of taps on the input interface. If the signature is verified to match a stored signature associated with the electronic device, access to the electronic device or the application to be executed on the electronic device is allowed.

### RELATED APPLICATIONS

This patent application claims priority from U.S. Provisional Patent Application No. 61/904,996, filed Nov. 15, 2014, entitled “System and Method for Identity Authentication,” the entirety of which is incorporated herein by reference.

### BACKGROUND OF THE INVENTION

### Field of the Invention

The present invention relates generally to online identity authentication and, more specifically, to behavioral biometrics in providing a biometrics-based unique signature of a user in authenticating a user input when the user is employing a system input device.

### DESCRIPTION OF THE RELATED ART

Identity theft is the world's fastest growing crime. With or without passwords, it is extremely important to know who the actual person is on the other side of any on-line transaction.

Currently, identity authentication and fraud prevention look mainly at circumstantial evidence, such as what the user has (e.g., magnetic cards, smart cards, hard tokens), what the user knows (e.g., user, password, personal data) and where the user is (geolocation), and typically combine two or more of these types of evidence. However, these methods are usually only sufficient to determine risk but not identity.

The problems with non-biometric solutions are that what the user has can be stolen and what the user knows can be discovered by malicious others. In fact, there is a burgeoning black market industry that makes malicious software, such as keyloggers, sniffers, phishing SDK's, Trojans and worms, that are freely downloadable from the Internet, readily enabling hackers to exploit systems, databases, social networks, emails, websites, other sensitive information, etc. Thus, in spite of having the latest and greatest “strong” authentication factors installed in most critical sites of the largest and most powerful institutions in the world, these networks still get hacked.

The problem with physical biometric solutions is that from the moment that there is a standard way to capture the physical pattern, there is also a standard way to reproduce that pattern. The pattern does not change and does not vary in different circumstances (this consistency is seen by the experts as a good thing, but for the online use case it is not). For example, fingerprints can be lifted off a glass and reproduced in thin film that is later used by the hacker to violate security. If hackers want access badly enough, it has been proven that these hackers will even resort to mutilation. Voice is probably the easiest biometric to hack as everybody has a hi-fi recorder in their pocket. Therefore, physical biometrics are risky, because these biometrics are easy to duplicate and because if everything else fails, hackers may resort to mutilation.

The problem with behavioral biometrics to date is that these biometrics have mostly been modeled after physical biometrics. Old habits die hard and the forensic origin of physical biometrics has inspired the idea of a central database of “all biometric patterns.” Basically, this implementation assists with being able to identify and convict a culprit after the fact, not prevent access. This is why keystroke dynamics, the detailed timing information that describes exactly when each key was pressed and when it was released as a person is typing at a computer keyboard, has tried to identify people by the way they type “any text in any circumstances,” which leads to trying to monitor the behavior of people in the continuum—undoubtedly, a flagrant violation of privacy. Besides the privacy issues, the lack of focus of behavioral biometrics on the circumstances (with some exceptions), and the lack of imagination in building the pattern recognition algorithms (frequently resorting to legacy algorithms such as standard fuzzy logic or neural networks), has led (with some exceptions) to poor accuracy.

In short, most authentication and fraud prevention solutions today have the following things in common: users do not like the solutions; these solutions are complicated or invasive; they are not pervasive (e.g., not available in many situations like when travelling, or for enrollment errors in physical biometrics); they are not natural; or the Total Cost of Ownership (TCO) is huge if the support cost (e.g., Help Desk assistance) is considered in the equation.

### BRIEF SUMMARY OF THE INVENTION

Embodiments of the present invention address a method of identity authentication that utilizes biological and behavioral evidence to reveal who the user is (physical and behavioral biometrics), what the user has (a tapping device) and what the user knows (the rhythm), so that the method is universally usable, yet cannot be mutilated or replicated.

In an embodiment of the present invention, a method, authentication server and computer program product authenticate an identity of a user of an electronic device using biometric behavior. The electronic device has an input interface for receiving tapping data. A signature for authorizing user access to the electronic device or an application to be executed on the electronic device is received. The signature comprises tapping data having been input to the electronic device by tapping a series of taps on the input interface. If the signature is verified to match a stored signature associated with the electronic device, access to the electronic device or the application to be executed on the electronic device is allowed.

In accordance with one aspect of the present invention, the input interface includes a touch screen display. In accordance with another aspect, the input interface includes a keyboard.

In accordance with yet another aspect of the present invention the stored signature is created by receiving a unique rhythm input by the user tapping a series of taps on the input interface, requesting the user to tap the unique rhythm a predetermined number of times to verify repeatability, if the unique rhythm is repeatable, creating the signature based on the unique rhythm. The unique rhythm may comprise a minimum number of taps. In one embodiment, the minimum number of taps is twelve.

In accordance with another aspect, an account of the user is registered by verifying the identity of the user. The identity of the user may be verified using National Institute of Standards and Technology (NIST) criteria. Upon registration, the electronic device upon which the user registered the account becomes a trusted device. An additional electronic device may be associated with the user account by registering the additional electronic device using the trusted device.

In accordance with still another aspect, multiple trusted electronic devices are associated with the user account. A request to authenticate the identity of the user is received from the electronic device and a notification is sent to each of the multiple trusted electronic devices informing of the request. If out-of-channel authentication is required, access is allowed only upon receiving a signature for authorizing user access from one of the multiple electronic devices other than the electronic device sending the request. If a cancel request is received from one of the multiple electronic devices, in response to receiving the cancel request, the electronic device from which the request to authenticate was received is de-authorized.

In accordance with another aspect of the present invention, the electronic device is a dumb phone and the input interface includes numeric keys. Telephone key tones corresponding to tapping a single numeric key are received at an interactive voice response server and converted into tapping data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration depicting an example authentication of a wireless device in accordance with one embodiment of the present invention;

FIG. 2 is a block diagram of example components of an identity authentication system using biometric behavior in accordance with one embodiment of the present invention;

FIG. 3 is a flowchart illustrating steps of an example method for registering an electronic device for use with the identity authentication system of FIG. 2, in accordance with an embodiment of the present invention; and

FIG. 4 is a flowchart illustrating steps of an example method for authenticating the identity of a user of an electronic device using biometric behavior according to an embodiment of the present invention.

### DETAILED DESCRIPTION OF THE INVENTION

An embodiment of the invention provide for a system and method of authenticating the identity of a user of an electronic device, such as a cellular telephone (both “smart phones,” i.e. phones which have more advanced computing capability and connectivity than basic feature phones, including natures typically associated with those of other consumer devices; and “dumb” phones, i.e. phones which are primarily limited to basic telephony functionality), wire-line phones, tablets, personal data assistants (PDAs), computers (e.g., laptop and computers), connected appliances, on-line vehicular navigation or information systems, websites, Automated Teller Machines (ATMs), smart car keys or any other on-line computing device requiring identity authentication.

The following detailed description is of the best currently contemplated modes of carrying out example embodiments of the invention. The description is not to be taken in a limiting sense, but is made merely for the purpose of illustrating the general principles of the invention, since the scope of the invention is best defined by the appended claims.

Broadly, an embodiment of the present invention provides an identity authentication system which verifies the identity of a device user via a tapping authentication procedure. The tapping authentication procedure (TAP) may include account registration, initial template/signature training, new device training, new device registration and operation authentication. The account registration may include the user establishing their identity with a TAP-delivering institution and the institution verifying the identity of the user. The initial template/signature training may include the user tapping a unique rhythm through a TAP-enabled application. The new device training may include installing the TAP-enabled application on a new device. The new device registration may include registering the new device through the TAP-enabled application.

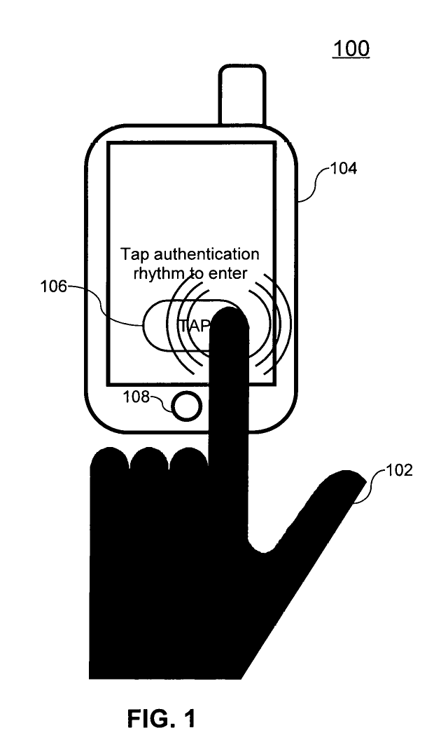

Referring now to FIG. 1, in one embodiment, an electronic device 100 equipped with a TAP-enabled application may authenticate a user's unique rhythm when identifying the user 102. The user, in response to a notification on a touch-screen display 104 of the electronic device 100, may enter the unique rhythm by tapping out the specific rhythm on the touch-screen display 104 at a location identified by a prompt 106. In other embodiments, the user may tap the rhythm on the electronic device 100 at a location of the touch-screen display 104 known only to the user, thus the location of the tapping may become part of the actual authentication. In other embodiments, such as for use with electronic devices having additional buttons or a keyboard, the user may tap the rhythm using the dedicated button, a specific key on the keyboard, a key of the keyboard known only to the user, a multiplicity of keys known only to the user, or any combination of the above. In certain embodiments, the TAP-enabled application may authenticate the identity of a user by combining analysis of the unique rhythm of the user with other identifying characteristics, for example, but not limited to, geo-location information, “out-of-channel identification,” what the user has (such as a registered tapping device), what the user knows (such as a password), or the like.

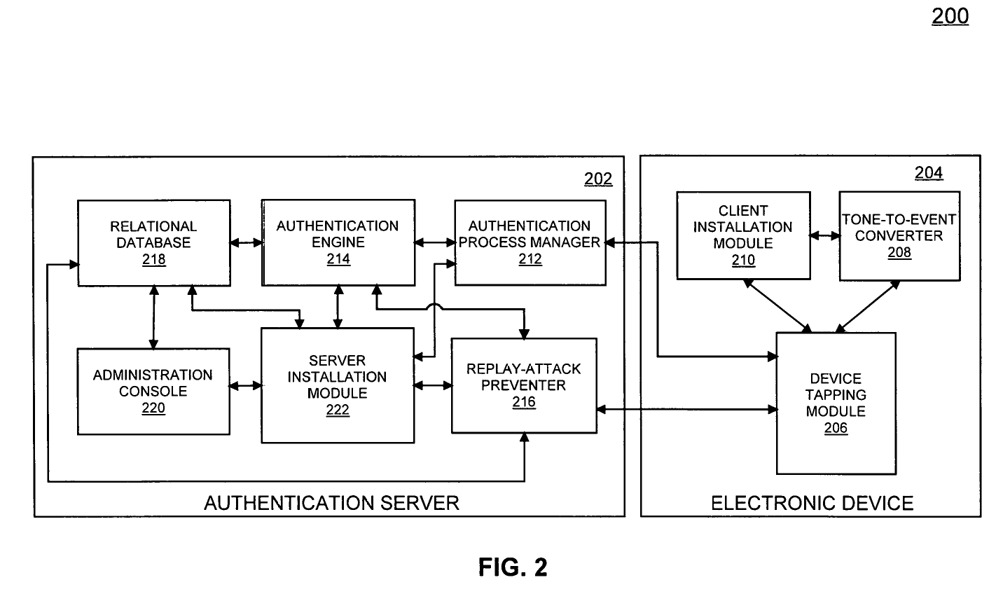

Referring now to FIG. 2, one embodiment of the present invention may include a tapping authentication procedure involving a plurality of components and a plurality of procedural steps. In some cases, the tapping authentication process may be invoked by an application prior to allowing the user access to the application; in other cases, the process may be invoked to allow any user access to a device itself. The plurality of components may include an authentication server 202 and at least one electronic device 204 to be authenticated. The electronic device 204 may include a device tapping module 206, a tone-to-event converter 208 and a client installation module 210. The authentication server 202 may include an authentication process manager 212, an authentication engine 214, a replay-attack preventer 216, a relational database 218, an administration console 220 and a server installation module 222.

The device tapping module 206 may include a Software Development Kit (SDK) and application for each platform supported by the authentication server 202. The device tapping module 206 has the necessary logic to build a signature on the electronic device 204 that receives the tapping events, register the device 202 in the system, and automatic login for Single-Sign-On capable devices. The device tapping module 206 may be replaced by a simple JAVASCRIPT™ implementation on a web server when the application is web-based.

The tone-to-event converter 208 may create signatures on an Interactive Voice Response (IVR) server (not shown) based on tapping done on the numeric keys of dumb phones. In this case the tone-to-event converter 208 converts telephone key tones into tapping times for IVR implementations, where the IVR server becomes the tapping device (i.e. the device which sends the sequence of taps).

The client installation module 210 provides automated installation of the device tapping module 206 and the tone-to-event converter 208 to supported devices. A client installation module 210 is needed for each device 204 the user wants to register. The client installation module 210 may be downloadable and comply with the specifications of any Application Store where people can download and install smartphone or tablet applications. The client installation module 210 should also be available in SDK format for developers who wish to integrate with other devices.

The authentication process manager 212 manages registration and authentication processes. The authentication process manager 212 may implement authentication business rules.

The authentication engine 214 trains, maintains, manages and compares stored tapping rhythm templates with a tapping instance. The replay-attack preventer 216 creates a unique environment for each tapping instance, such that the tapping instance cannot be replayed later.

The relational database 218 includes storage capability for templates, authentication logs and other system information. Each user may have multiple electronic devices registered for use with the identity authentication service (i.e. “trusted devices”) and each registered device may be associated with multiple users.

The administration console 220 consists of tools that provide for configuration and administration of the identity authentication system 200. The administration console 220 may be a website that is authenticated using the tapping authentication procedure. The administration console 220 enables the system administrator to administrate organizations, users, applications and transactions, as well as templates per device and per user, and security options. The administration console 220 may allow the Administrator to provision, de-provision and re-provision the tapping authentication process for a user and device type; monitor the system logs; filter flag return values to generate alarms for fraud prevention; verify overall system performance; filter logs per company (i.e. institution), application, device type and user; administrate patterns, monitor system servers, etc. The functionality of the administration console 220 is the sole decision of the institution.

The server installation module 222 provides automated installation of the authentication server 202 components. The server installation module 222 may only be necessary when an institution wants to install in its own data center. A system provisioning process may be necessary when an institution wants to use a cloud service. Depending on the implementation, the server installation module 22 may or may not include a relational database management system, an application server, a web server and other infrastructure that will depend on the architecture selected to implement these services.

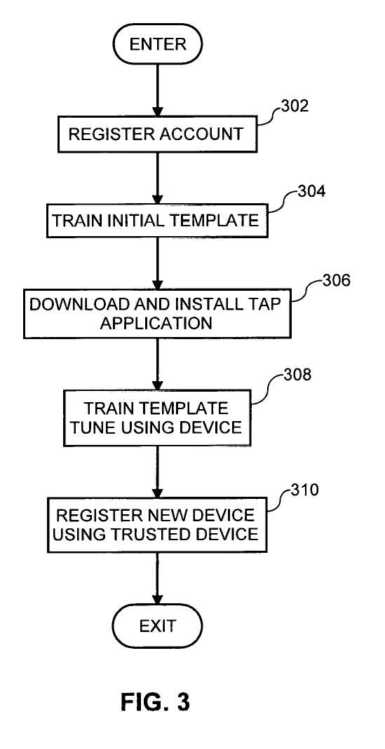

Referring now to FIG. 3, a flowchart 300 is provided illustrating steps of an example method of registering an electronic device 204 for use with the identity authentication system 200. The process begins, at step 302, by registering an account. Account registration may be done on a website or using an application (i.e. a smartphone or tablet application) that may be provided by the institution that delivers TAP. The institution may focus on initially verifying that the person registering is who he says he is. In certain embodiments, this step may be done using National Institute of Standards and Technology (NIST) criteria. The more critical the operation, the higher the NIST level to be achieved. After verification, the user may enter at least the following minimum account data (more, if determined by the institution): full name; a unique userID (which may be generated automatically by the institution); an email address for notification; and a cellular phone for notification; all validated traditionally by email and Short Message Service (SMS). In certain embodiments, the device on which the account registration may be done becomes a “Trusted” device, which means that device can be used to register other devices that will also be trusted without going through the NIST verification.

The initial template/signature is trained (at step 304) by identifying a rhythm of taps entered by the user on the electronic device 204. The user may be prompted to type his rhythm using a tapping button indicated by the website or application. In touch screen devices, this may be done by tapping the screen where the tapping button appears. In other devices the rhythm may be entered by pointing and clicking or typing on a specific key (this may be determined during the device installation process). Once the tapping mechanism for that device is devised, the user proceeds to train his rhythm (i.e. create a signature) by retapping the rhythm a predetermined number of times to verify that the rhythm is repeatable. It is suggested that the user choose a song he likes and tap to the rhythm of a certain number of syllables of the song. A minimum of twelve taps (i.e. syllables) is recommended. For example, if the user chooses the chorus of Paul McCartney's “Let it Be,” he would tap to: “Let it be, let it be, let it be, oh, let it be” where each word may be one tap, resulting in: “tap tap tap, tap tap tap, tap tap tap, tap, tap tap tap”—14 taps. Obviously, the user can invent his own rhythm, but it is important that he be able to remember it, because it may be his sole means of authentication. The signature is stored in the relational database 218. There is no remedy for forgetting a rhythm, except training a new one.

The computer or other device on which the user accessed the registration website is the tapping device administrator. Initially, the user will be able to register smart phones and in cases where the institution that provides TAP also provides an IVR interface for dumb phones (land lines or regular cellular phones). Here the user needs to log in to the site from his computer and supply the telephone numbers of his personal phones that will then be allowed to download the tapping application and train the rhythm for each phone registered.

When the user registers an electronic device (e.g., a smart phone) he is prompted to download (at step 306) and install the tapping application for the device. Once the installation is complete, the user may proceed to train (at step 308) the template tune for that device by tapping on the button supplied or identified in the application. When the device establishes communication with the authentication process manager 212, it uploads the sentence that the user registered in the initial registration. This sentence is used to create an anagram that identifies the user on that specific device as the user types his tune. This anagram will serve as user-device identification. When the user registers a dumb phone the user taps using always the same numeric key the sound is received by the IVR server that proxies for a smart phone. The IVR server receives the tapping rhythm in tone format and converts tones to a key-down, key-up timestamp vector that it includes in the payload when invoking the authentication process manager.

If the user decides to add a new device, he proceeds to install the application that uses TAP (e.g., Online Banking application, Single-Sign-On (SSO) application, etc.). When the user starts the application or invokes a website application from a device type that has not been trained, he may first be asked to register the device, and if this device is detected to be an untrained device type he may be prompted to train his rhythm for that device type. The user may add “Trusted” devices by simply registering (at step 310) the new device using a “Trusted” device. Registration may be invoked by attempting to sign in with the new device to a TAP-enabled application or website. The user may be notified that the device needs registration and asked to select from a list of trusted devices from which he can authorize the device (and may be asked to enter a name for the device being authorized). The user may then go to the “Trusted” device he selected and authorize the new device.

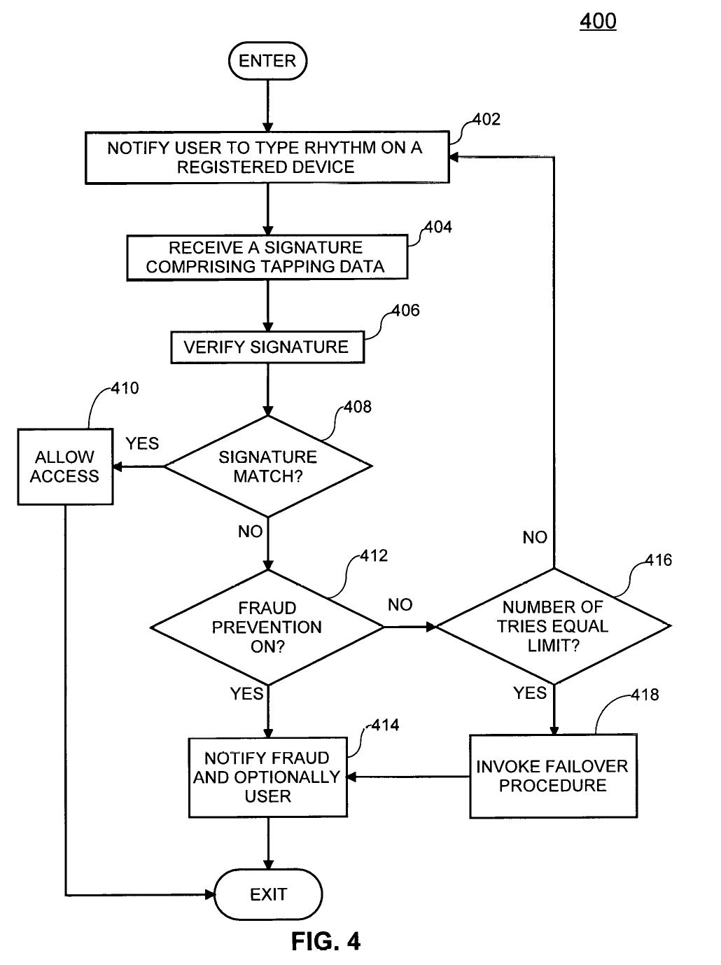

Turning now to FIG. 4, a flowchart 400 is provided illustrating an example process for authenticating the identity of a user of an electronic device 204 using biometric behavior of the user according to one embodiment of the present invention. When the user or another system wants to initiate a session on any website or application with a given device, the user is notified (at step 402) by the application that is requiring authentication or the authentication server 202 to type his/her rhythm on a registered device. A complete set of trusted devices associated with that user which have the tap authorization application installed or have access to that website, may be notified of the attempt.

The application or system prompts the user to tap his rhythm (optionally showing him an anti-phishing image, if same-device-tapping is allowed) and stating something like “Welcome [user name], please tap your rhythm on [This, Other, This or Other] device.” Besides this phrase, the application or system may display a button that says “Not [user name],” a button that states something like “Tap Here,” and another button that states something like “Cancel.”

Depending on the default security level required for the specific website or application, out-of-channel authentication may be required. In this case the user may tap his rhythm on any of the devices notified—except the device on which he may be initiating the session. In certain embodiments, if the user is logging in to a website on his computer and out-of-channel authentication is required for that website, he may be notified on his registered smart phone, and may need to tap his authentication on the smart phone, rather than on the computer.

The identity authorization system 200 waits for the user to do one of the following:
1) Tap on the current device when allowed (i.e. out-of-channel authentication not necessary).
2) Tap out-of-channel on a trusted device that is reachable (e.g., a cell phone).
3) Select the “Not [user name]” button.
4) Select the “Cancel” button.

In any case, when the user is notified on any device that he has a pending authorization, he may attempt to cancel the transaction by clicking on the “CANCEL” button. The user may be notified if the “CANCEL” request was successful, and the device through which tapping authentication was being attempted may be de-authorized, become untrusted, and may need to be authorized again by a trusted device. If the user opts to “Cancel”, it is normally because he receives a notification on a trusted device where he is the default user, asking him to authenticate access to an application on another device. If the user realizes it's an impostor, and therefore cancels the authentication (if on time) and/or alerts the institution that supplies the TAP-enabled application that there is an impersonation in-progress on the other device. The device is immediately de-authorized (set to “Not Trusted”) to minimize damage. So, for example, if an impostor attempts to authenticate a wire transfer in session, he will be unable to do so. The device will need to be set to “Trusted” again—through a trusted device that the legitimate user taps into.

If the user is not the default user on the device, once the user selects the “Not [user name]” button, he is asked to enter his userID. In applications requiring highest security, the user typing can be monitored through keystroke dynamics, and the device must be a trusted device. In normal security situations, the device must be a trusted device, but the authentication of the user will be unnecessary. In low security situations, the user will be allowed to simply enter his userID into any previously trained device type (even if not trusted), and the authentication server 202 will notify all trusted devices that an authorization attempt is happening. This process allows the real user to hit the “Cancel” button on a trusted device—or allow the legitimate user to tap into a trusted device and authorize the new device as a secondary user.

The authentication process manager 212 receives (at step 404) the tap data from the client application or web application when the user finishes tapping on any trusted device. This is called “tap submission.” The authentication process manager 212 begins executing an authentication process which may include verifying (at step 406) a user signature. If the signature matches (at step 408) the signature stored in the relational database 218 for the registered device, access to the application or electronic device is allowed (at step 410) and the tap-enabled application lets the user in (or, if it is a single-sign-on application, issues an authenticated token, and the authentication process manager 212 notifies the user that he has been recognized).

If the signature does not match (at step 408) and the fraud prevention mode is enabled (at step 412), fraud prevention measures may be invoked. Fraud prevention measures may include asking the user once again to verify the signature and notifying (at step 414) the Fraud Department (e.g., of the institution) and optionally, the user.

However, if the fraud prevention mode is not enabled (at step 412), the authentication process manager 212 determines (at step 416) if the number of tries (i.e. authentication attempts) for the registered device and user combination is lower than a predetermined limited, customizable by the institution. If the number of tries is lower than the limit, then the process returns to step 402 to notify user to re-enter their rhythm on the registered device. If the number of tries is equal to the limit, failover procedures may be invoked (at step 418).

Failover procedures, in certain embodiments, may include the use of other second-factor authentication capabilities such as a using one time password (OTP), using an SMS OTP (i.e. a one time password via SMS), answering security questions, physical biometrics, coordinate cards, call center intervention, etc., in whatever combination makes sense to override a false negative without producing a false positive. The user is prompted to do whatever the institution requires to resolve failed tappings. If the failover procedure is passed, the user is allowed into the application. Failover procedures should be implemented ad hoc for each application, device or institution.

Once the user has at least one “Trusted” device and that device type has been trained, the operation may be as follows:
1) In Session Authentication (for use cases such as online financial transactions, etc., where the user has already tapped into the session, but it is necessary to verify out-of-channel that the user continues to be the original user and not a Man-In-The Middle (MITM) or Man-In-The-Browser (MITB) attacks, all OTHER Trusted Devices with the application installed (or web application accessible) will be notified. The user will be prompted to tap his rhythm (or hit “Cancel” as discussed above) before granting access or approving the transaction. This simple capability will disarm most MITM and MITB attacks.
2) Access Authentication—This capability may be used to authenticate who may be trying to access almost anything: for example, to start the car engine, to access a home, to access a session on any ATM, to access a vault, and many other possibilities.

Additionally, the device tapping module 206 may include an alternative method that can be used in a login application that invokes the authentication process manager 212. The method builds a userID based on the user's full name, the number of syllables in his tapping rhythm, and the hexadecimal value of the nibbles formed by four “1 or 0” values for each tap syllable in sequence (depending on the value of the 1^{st} derivative of the time vector of each syllable in the time/syllable axes). This method allows the dynamic construction on the client side that is reproduced on the server side, and renders a unique userID (as long as the user does not change the Tapping Rhythm or number of syllables). All subsequent userID's will be mapped to the first one that is created, or to the one that is being replaced (in the case that it exists). To make brute force discovery of the userID more difficult, any userID created this way may be encrypted using the creation timestamp as a one-time encryption seed. This feature allows for identification and authorization to be done by the tapping rhythm, and for enabled devices, will allow users to identify themselves by simply using their full name.

Also, while the replay-attack preventer 216 is more than sufficient to avoid replay attacks (replacing the payload using an event logger and creating a fake payload), it is may not be sufficient to fend off a malicious robot that can simulate the tapping being installed as a Trojan on the tapping device. By opening a microphone on the electronic device 204 and recording the sound of the user tapping, it will be much more difficult for a robot to simulate the tapping, because the coincidence of the sound and the tap timing may be checked and verified. In order for a robot to simulate the tapping, it would require the robot to fake the sound in some way, and emulate the specific frequency spectrum of that instance of tapping. Tracking the usual place where the user taps on the screen or keyboard, and comparing it to this specific instance, could attain a similar result.

Additionally, the core tapping data collection method may be delivered by hardware, allowing for higher accuracy and avoiding Trojans that could change the tapping rhythm at registration time because the device tapping module 206 would always resort to the native and trusted hardware method.

The tapping authentication procedure may also be used as an authentication factor for e-commerce, gaming and gambling, healthcare, entertainment, self service and other applications implemented as websites, smartphone or tablet applications—and as a fraud prevention mechanism where in-session authentication is needed. It can also be used as a way to avoid MITM and MITB attacks, using it as an out-of-channel verification to approve ATM transactions and sensitive online transactions. It may be used for any online application in need of strong security. It is pervasive because almost anyone, even people with severe handicaps, can type a rhythm.

The tapping authentication procedure may be used to secure access to cloud applications (e.g., GOOGLE™ Apps), and all sorts of password vaults, other digital vaults, databases, document storage, etc.—either in the cloud, behind a firewall or on the device.

The tapping authentication procedure has potential for many other uses such as smart car keys that only start the car if one types in the rhythm correctly or overrides the verification. This could be a great crime prevention capability, because the police and the user could be notified instantaneously if somebody that is not a registered user started the car engine. This could also be achieved by tapping the rhythm on the user's cell phone in lieu of a car key. The same can be said to activate and deactivate house and car alarms remotely. It can also be used to access intelligent homes appliances, to add security to a vault or a missile launcher, or to be granted access into a high security facility or classified information.

The applications are many, and in many fields, because tapping can be performed on a computer, a tablet, a smart phone, a regular phone, and any device that has a tappable input interface.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of authenticating an identity of a user of an electronic device using biometric behavior, the electronic device having an input interface, the method comprising:
receiving a signature for authorizing user access to at least one of the electronic device and an application to be executed on the electronic device, the signature comprising tapping data, the tapping data having been input to the electronic device by tapping a series of taps on the input interface;
verifying that the signature matches a stored signature associated with the electronic device; and
if the signatures match, allowing access to the at least one of the electronic device and an application to be executed on the electronic device.

2. The method of claim 1, wherein the input interface includes a touch screen display.

3. The method of claim 1, wherein the input interface includes a keyboard.

4. The method of claim 1, further comprising creating the stored signature by:
receiving a unique rhythm input by the user tapping a series of taps on the input interface;
requesting the user to tap the unique rhythm a predetermined number of times to verify repeatability; and
if the unique rhythm is repeatable, creating the signature based on the unique rhythm.

5. The method of claim 4, wherein the unique rhythm comprises a minimum number of taps.

6. The method of claim 5, wherein the minimum number of taps is twelve.

7. The method of claim 1, further comprising registering an account of the user by verifying an identity of the user.

8. The method of claim 7, wherein the identity of the user is verified using National of Standards and Technology (NIST) criteria.

9. The method of claim 7, wherein upon registration, the electronic device upon which the user registered the account becomes a trusted device.

10. The method of claim 9, wherein an additional electronic device is associated with the user account by registering the additional electronic device using the trusted device.

11. The method of claim 10, wherein multiple trusted electronic devices are associated with the user account, the method further comprising:
receiving a request to authenticate the identity of the user from the electronic device; and
sending a notification to each of the multiple trusted electronic devices informing of the request.

12. The method of claim 11, wherein out-of-channel authentication is required, the method comprising allowing access only upon receiving a signature for authorizing user access from one of the multiple electronic devices other than the electronic device sending the request.

13. The method of claim 11, further comprising:
receiving a cancel request from one of the multiple electronic devices; and
responsive to receiving the cancel request, de-authorizing the electronic device from which the request to authenticate was received.

14. The method of claim 1, wherein the electronic device is a dumb phone and the input interface comprises numeric keys, the method further comprising:
receiving telephone key tones corresponding to tapping a single numeric key at an interactive voice response server; and
converting the telephone key tones into tapping data.

15. An authentication server for authenticating an identity of a user of an electronic device using biometric behavior, the electronic device having an input interface, the authentication server comprising:
a communication interface that receives a signature for authorizing user access to at least one of the electronic device and an application to be executed on the electronic device, the signature comprising tapping data, the tapping data having been input to the electronic device by tapping a series of taps on the input interface; and
a processor, communicatively coupled to the communication interface, the processor:
verifies that the signature matches a stored signature associated with the electronic device; and
if the signatures match, allows access to the at least one of the electronic device and an application to be executed on the electronic device.

16. The authentication server of claim 15, wherein the processor further creates the stored signature by:
receiving a unique rhythm input by the user tapping a series of taps on the input interface;
requesting the user to tap the unique rhythm a predetermined number of times to verify repeatability; and
if the unique rhythm is repeatable, creating the signature based on the unique rhythm.

17. The authentication server of claim 16, wherein the processor further:
registers an account of the user by verifying an identity of the user; and
upon registration, the electronic device used to register the account becomes a trusted device.

18. The authentication server of claim 17, wherein multiple trusted electronic devices are associated with the user account, the communication interface further:
receives a request to authenticate the identity of the user from the electronic device; and
sends a notification to each of the multiple trusted electronic devices informing of the request.

19. The authentication server of claim 18, wherein out-of-channel authentication is required, processor allowing access only upon receiving a signature for authorizing user access from one of the multiple electronic devices other than the electronic device sending the request.

20. A computer program product for authenticating an identity of a user of an electronic device using biometric behavior, the electronic device having an input interface, the computer program product comprising a computer readable storage medium having program instructions embodied therewith, the program instructions executable by an authentication server to cause the authentication server to perform a method comprising:
receiving a signature for authorizing user access to at least one of the electronic device and an application to be executed on the electronic device, the signature comprising tapping data, the tapping data having been input to the electronic device by tapping a series of taps on the input interface;
verifying that the signature matches a stored signature associated with the electronic device; and
if the signatures match, allowing access to the at least one of the electronic device and an application to be executed on the electronic device.
